(19) United States
(12) Patent Application Publication
(10) Pub. No.: US 2013/0232427 A1
(43) Pub. Date: Sep. 5, 2013

(54) METHOD AND SYSTEM FOR COMMUNICATING INFORMATION ASSOCIATED WITH AN INCIDENT TO A DESIGNATED GOVERNMENT PUBLIC SAFETY AGENCY

(71) Applicant: Luis G. Romero, San Juan, PR (US)

(72) Inventor: Luis G. Romero, San Juan, PR (US)

(73) Assignee: OPTIVON INC., Guaynabo (PR)

(21) Appl. No.: 13/884,857

(22) PCT Filed: Sep. 10, 2012
(86) PCT No.: PCT/US2012/054485

§ 371 Date: May 10, 2013

Related U.S. Application Data
(60) Provisional application No. 61/532,363, filed on Sep. 8, 2011.

(51) Int. Cl. H04L 29/06

(52) U.S. Cl. CPC H04L 65/403
USPC 715/753

(57) ABSTRACT

A method and system for communicating information associated with an incident to a designated government public safety agency. Displaying a plurality of selectable icons each associated with a type of criminal offense on the display of the device for the user to select the type of criminal offense associated with the incident, displaying on the display of the device a text box and/or at least one other selectable option for allowing the user to optionally take or select a photo, a video, or an audio recording associated with the incident. Preparing and transmitting a message to a receiving system of the designated government public safety agency, the message including one or more of the user identification and/or contact information, the location-based information, the selected type of criminal offense, text information associated with the incident, photo information associated with the incident, video information associated with the incident.

### BACKGROUND

1. Field of Invention

The invention relates generally to crime prevention and improved information sharing with law enforcement and, more particularly, to a method and system for communicating information associated with an incident to a designated government public safety agency.

2. Discussion of Related Art

Information sharing between law enforcement and other government public safety agencies is an important part of crime prevention and reduction efforts. Many citizens report incidents or suspected criminal activity to local, state, or federal law enforcement via phone hotlines or online via browser-based web pages associated with respective agencies. These information submission vehicles, however, have limitations on the amount, type, and timeliness of the information submitted.

What is needed are new modes of incident information submission to law enforcement which take advantage of the widespread and ever-growing use of smartphones and other intelligent devices by the general public.

### SUMMARY

In an embodiment of the invention, a method for communicating information associated with an incident to a designated government public safety agency is provided. The method may include displaying a setup screen on a display of a device for a user to optionally enter or select user identification information and/or user contact information, displaying on the setup screen, or on a different setup screen, on the display of the device, a selectable option for allowing the user to optionally enable location-based information, displaying a plurality of selectable icons each associated with a type of criminal offense on the display of the device for the user to select the type of criminal offense associated with the incident, displaying a text entry region on the display of the device for allowing the user to optionally enter text information associated with the incident, and displaying on the display of the device at least one other selectable option for allowing the user to optionally take or select a photo, a video, or an audio recording associated with the incident. The method may include preparing, by the device, a message to send, the message including one or more of the user identification information, user contact information, the location-based information, the selected type of criminal offense, text information associated with the incident, photo information associated with the incident, video information associated with the incident, and/or audio information associated with the incident, and sending, by the device, the message to a receiving system of the designated government public safety agency.

According to an embodiment, the message may be in the form of an email, an SMS message, an MMS message, or any other suitable data transmission mechanism or communication format available in cellular or Wi-Fi networks or a dedicated public safety wireless network including those used by public safety entities to receive and report emergencies or register incidents. Two-way communication between the user device and the receiving system of the designated government public safety agency is envisioned.

According to an embodiment of the invention, a system for communicating information associated with an incident to a designated government public safety agency is provided. The system may include means for implementing the aforementioned method.

Further features and advantages, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of some example embodiments of the invention, as illustrated in the accompanying drawings. Unless otherwise indicated, the accompanying drawing figures are not to scale. Several embodiments of the invention will be described with respect to the following drawings, in which like reference numerals represent like features throughout the figures, and in which:

FIG. 1 illustrates an example block diagram of a system for communicating information associated with an incident to a government public safety agency according to an illustrative embodiment;

FIG. 2 illustrates an example graphical user interface including a selectable application icon configured to launch an application for communicating information associated with an incident to a government public safety agency according to an illustrative embodiment;

FIG. 3 illustrates an example user interface for entering user specific information and changing location and identification settings according to an illustrative embodiment;

FIG. 4 illustrates an example user interface for selecting a type of incident witnessed or being reported according to an illustrative embodiment;

FIG. 5 illustrates an example user interface for entering further information related to the incident to be reported including time, date, description, and optional photo, video, and/or audio information according to an illustrative embodiment;

FIG. 6 illustrates an example user interface for selecting photo or video information for inclusion in an incident report message according to an illustrative embodiment;

FIGS. 7 and 7A illustrates example user interfaces for optionally recording audio to be attached and included in the incident report message according to an illustrative embodiment;

FIG. 8 illustrates exemplary processing for a user (sending) device according to an illustrative embodiment;

FIG. 9 illustrates a screen shot of an example information screen including selectable icons for obtaining web-based information available from the designated government public safety agency according to an embodiment;

FIG. 9A illustrates a screen shot of an example screen 906 including nearby physical locations of the designated government public safety agency; and

FIG. 10 schematically illustrates a device that may be used in association with, in connection with, and/or in place of, but not limited to, any of the foregoing components and/or systems to implement the example methods described herein.

### DETAILED DESCRIPTION

Some embodiments of the invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the invention. All references cited herein are incorporated by reference as if each had been individually incorporated.

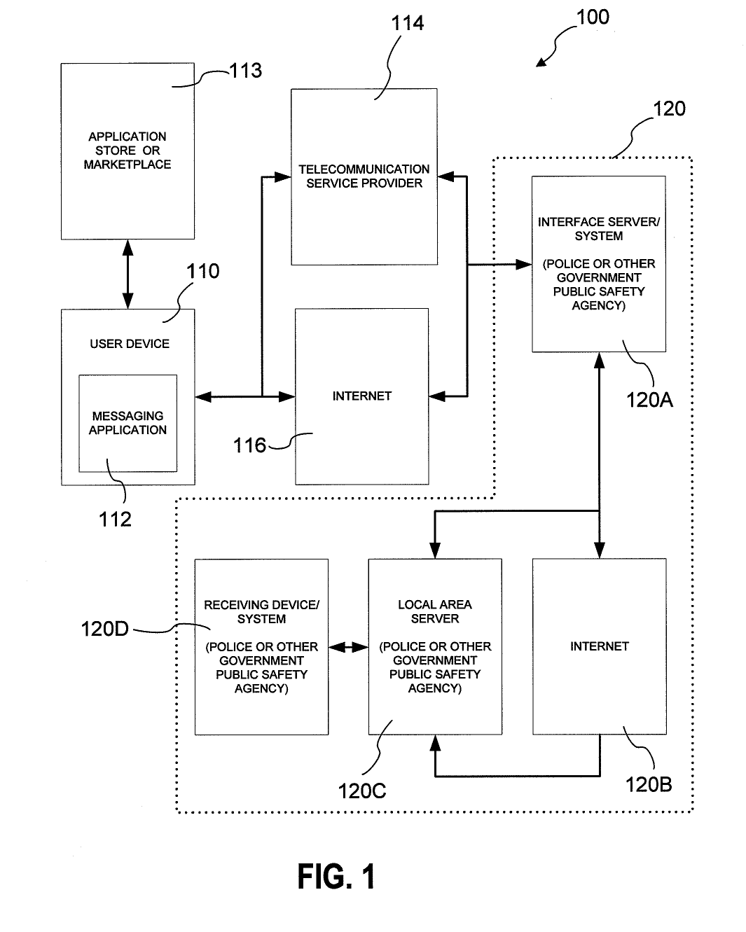

FIG. 1 depicts an example block diagram of a system 100 for communicating information associated with an incident to a government public safety agency according to an illustrative embodiment. As shown in FIG. 1, a mobile user device 110 may include a stored mobile software application 112 so as to be operable by a user to communicate information associated with an incident to an interface server 120A of a receiving system 120 of a government public safety agency such as, for example, a 9-1-1 service bureau. The interface server 120A, in turn, may communicate with either an incident reporting and management system 120C and/or a computer device 120D of the receiving system 120. Broadly speaking, the application 112 may enable the user to gather and send incident-related information in a user friendly way to the receiving system 120 of the government public safety agency (e.g., the police). The incident-related information may include one or more of photo, video, voice (audio) recording(s), descriptive text information, together with (optionally) the GPS location of the mobile user device 110, the name of the user, cell phone number, electronic serial number of the user device, and date and time as described further below.

The user device 110 may communicate wirelessly with the interface server 120A of receiving system 120, for example via the user's telecommunication service entity 114 and/or via a public data communication network 116 such as the Internet, to provide relevant and timely information associated with the incident for either immediate emergency response or a slower process of incidence reporting and analysis. The communication between the messaging application 112 of the user device 110 and the interface server 120A of receiving system 120 may be two-way in nature. For instance, an incident record number could be generated by the interface system 120A upon receipt of an incident report and returned to the user device 110. The messaging application 112 can receive and store such information so that, for example, the user can follow-up at a later time with the police or public safety agency regarding the reported incident if desired. Server 120A may also communicate with user device 110 via two-way communication to accommodate transmission of reverse 9-1-1 emergency notices, amber alerts, and other types of communications generated by the police or public safety agency and sent to the user device 110. Data transmission mechanisms between the user device 110 and the receiving system 120 may include, for example, but not limited to, Circuit Switched Data (CSD), High-Speed Circuit-Switched Data (HSCSD), General Packet Radio Service (GPRS), Enhanced Data Rates for GSM Evolution (EDGE) (E-GPRS), Universal Mobile Telecommunications System (UMTS) or Long Term Evolution (LTE) to communicate with the cellular system data servers.

As shown in FIG. 1, the user device 110 may have obtained the application 112 by connecting to a remote server providing a virtual vendor or marketplace (e.g., Apple iTunes App Store, Android Market, Blackberry® App World, and the like) where the application 112 is offered, and selecting and downloading the software application 112 in a manner known to those of ordinary skill in the art.

The mobile user device 110 may be an Internet and multimedia-enabled smartphone or tablet, with or without touch screen capability, such as, for example but not limited to, an Apple iPhone (e.g., iPhone 3G, iPhone 4, etc.), an Android™ phone, a Blackberry® phone or device, an Apple iPad, an Android™ tablet, or a Blackberry® Playbook. The government public safety agency may be, for example but not limited to, state, county, or local police or fire departments, state or local crime watch agencies, or any number of federal agencies such as, for example but not limited to, the FBI or the like, the Coast Guard or the like (including its Reserve and Auxiliary components), the Forestry Service or the like, or the Environmental Protection Agency or the like.

The interface server/system 120A may be configured for two-way communications, data storage and processing, secure transmission and inter-system communication. By handling these various functions, multi-media payloads sent from a user device 110 may be processed and routed to a computer receiving device/system 120D. For example, interface server 120A of receiving system 120 may contain one or more of an operating system (e.g., Linux®, Microsoft® Server 2008, etc.), a database software (i.e. Microsoft® SQL, MySQL), a general-purpose server-side scripting language (PHP or Microsoft's Active Server Pages (ASP)), a web server application and set of feature extension modules to work with the operating system and scripting language that supports HTTP, HTTPS, FTP, FTPS, SMTP and NNTP (i.e. Microsoft® Internet Information Services (IIS)), Network Address Translation (NAT) and Port Address Translation (PAT) software, a transmission error correction method, a password management software, a virtual private network (VPN) and data encryption software, a software for enabling communication between two or more systems (e.g., Microsoft® Web Service using Visual Studio, Simple Object Access Protocol, an Application Programming Interface, or other inter-system communications methods), and/or a remote management software. Interface server/system 120A may be configured to manage two-way communication with the messaging application 112 as well as two-way communication with a receiving device 120D of the designated government public safety agency via a local area server 120C of the public safety agency's incident reporting and management system or via the Internet 120B.

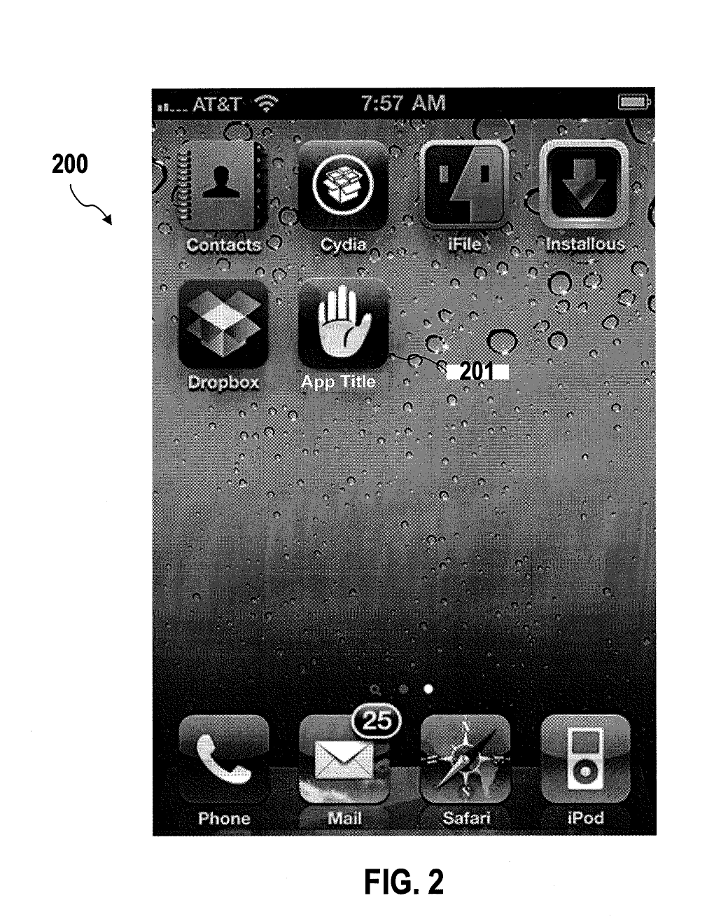

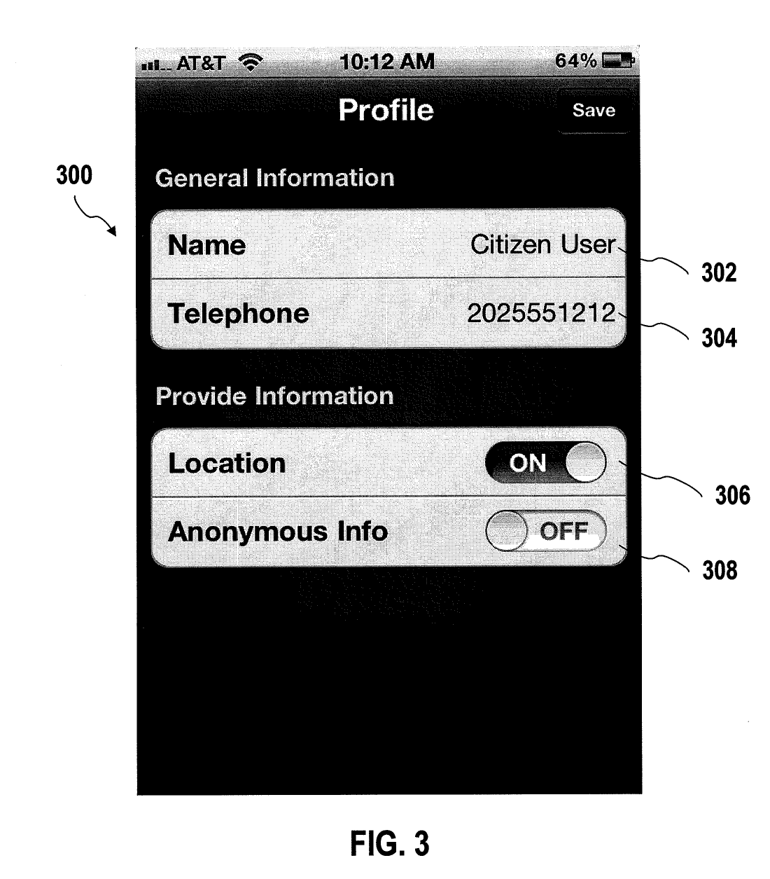

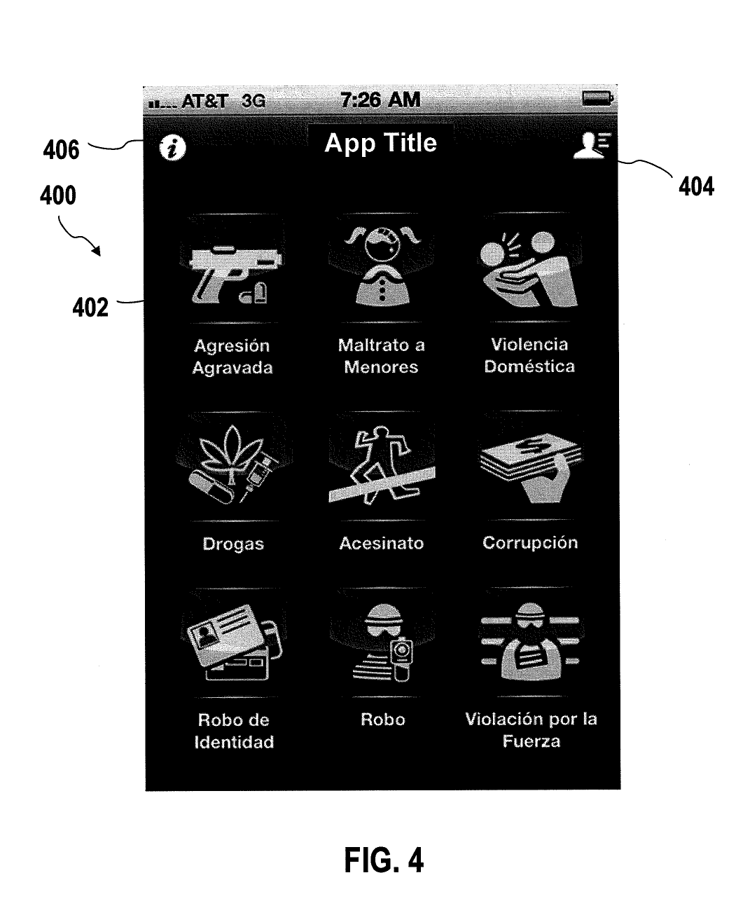

FIG. 2 illustrates an example graphical user interface on a display 200 including a selectable application icon 201 configured to launch the software application 112 for communicating information associated with an incident to a government public safety agency according to an illustrative embodiment. For example, if the user witnesses a crime, the user may select icon 201 such as by touching on a touch screen display 200, to launch the application 112. When the user selects the icon 201, one of a setup page (screen) 300 (see FIG. 3) or a user interface screen 400 (see FIG. 4) may pop up initially. FIG. 3 illustrates an example setup page 300 for allowing a user to enter user-specific identification and/or contact information as well as changing location and identification settings according to an illustrative embodiment. For example, the setup page 300 may allow the user to enter or select his/her name and cell phone number in selected fields 302, 304, respectively. The setup page 300 may also include a selectable option or field 306 to allow the user to decide whether to allow GPS (location-based) data to be transmitted with the incident information (report). The setup page 300 may also include another selectable option or field 308 to allow the user to decide whether to send the report anonymously. The aforementioned selectable options or fields may also be presented together or separately on other, different screens or pages described below. Furthermore, at some point after launching the application, and before or during the generation or submission of the incident report, the user may be required to signify acceptance of an end user license agreement (EULA) not shown or described further herein.

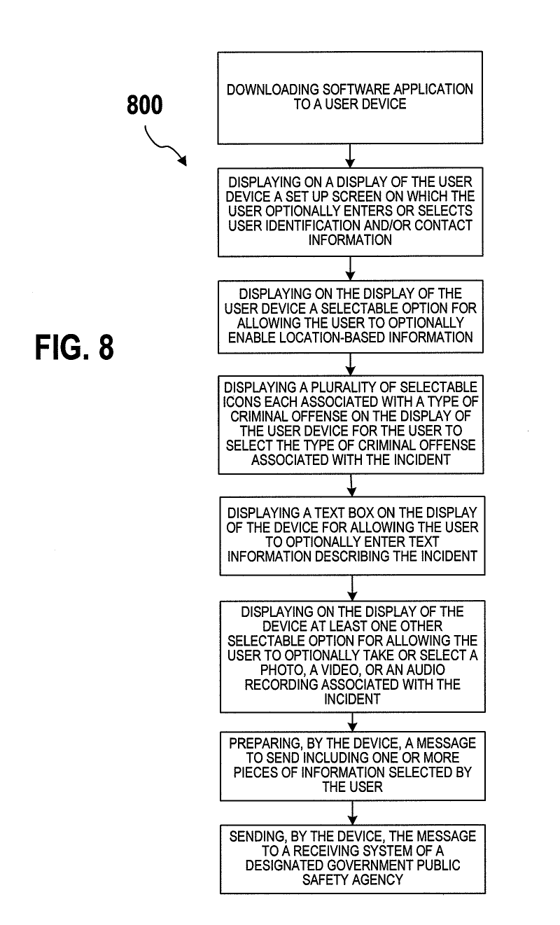

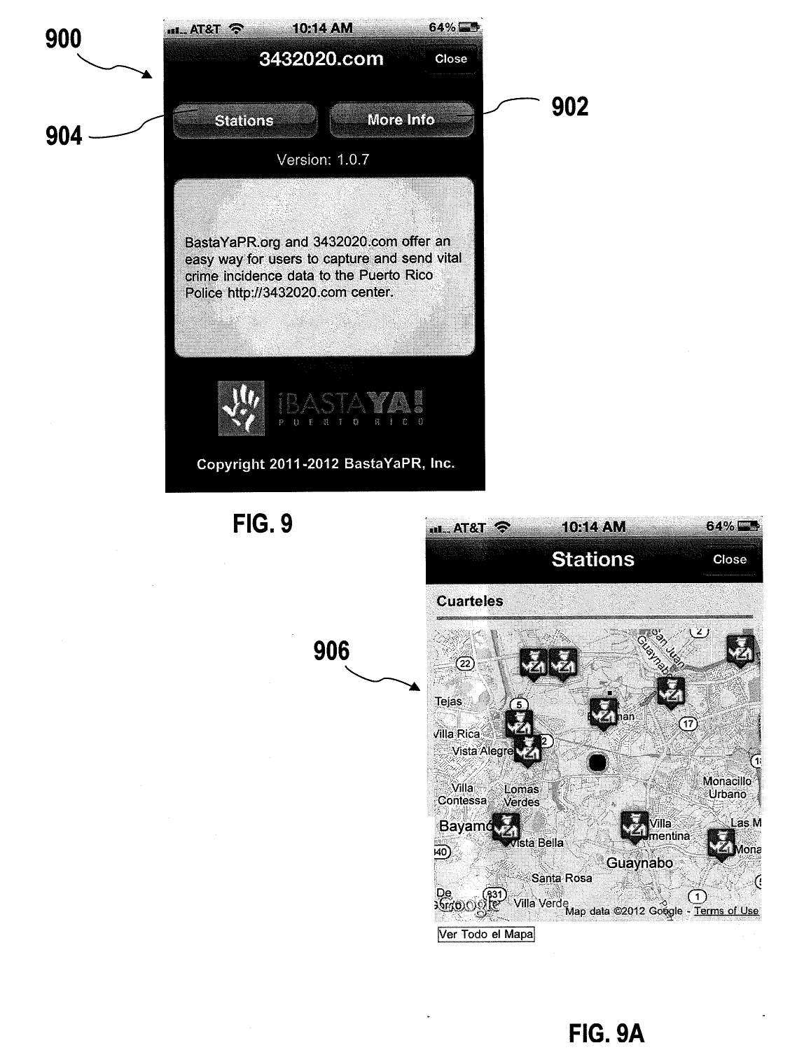

Upon launching the application 112, or after the user information and preferences are entered and saved via setup page 300 (e.g., by selecting or pressing “Save” or “Guardar”), the application 112 may display the example user interface 400 shown in FIG. 4 to allow the user to select a type of incident witnessed or being reported according to an illustrative embodiment. In the example user interface shown in FIG. 4, nine different selectable icons 402 corresponding to various crime types are displayed, each with an easy to understand illustration. For example, FIG. 4 includes an icon 402 for each of the following crimes: aggravated aggression (e.g., assault and/or battery), mistreatment of minor children, domestic violence, drugs, murder, corruption, identity theft, robbery (e.g., armed), forcible rape. More or less than nine icons and corresponding types of incidents/crimes are possible as would be apparent to one of ordinary skill in the art. As shown in FIG. 4, an icon 404 may be provided within user interface 400 to allow the user to go or return to the setup page 300 (see FIG. 3) to enter, select, remove and/or modify information and settings as desired. As shown in FIG. 4, another icon 406 may be provided within user interface 400 to allow the user to go to another information page 900 (see FIG. 9) to optionally obtain web-based information from the designated government public safety agency as described further below.

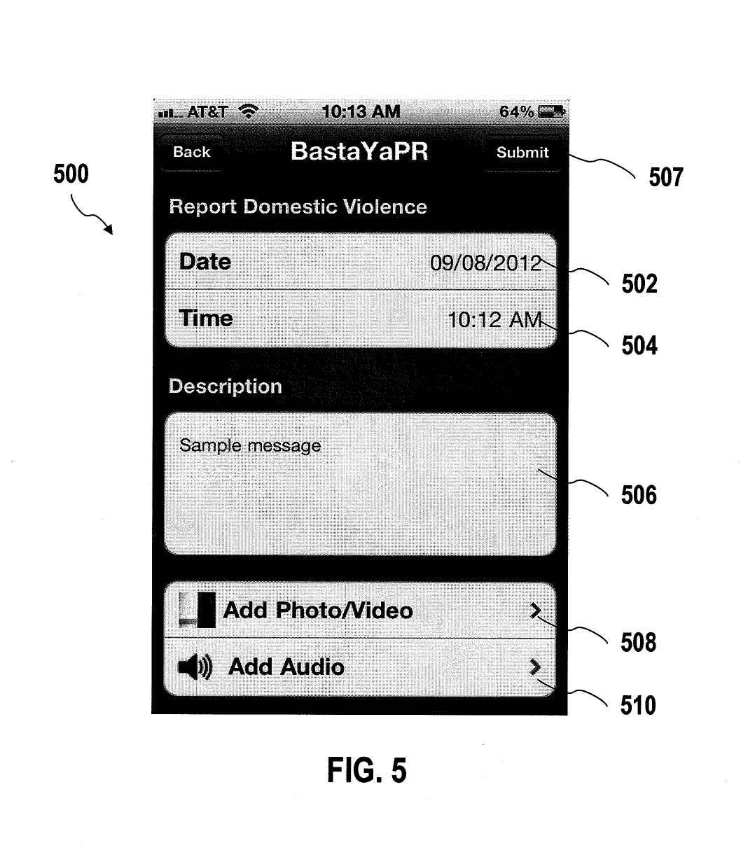

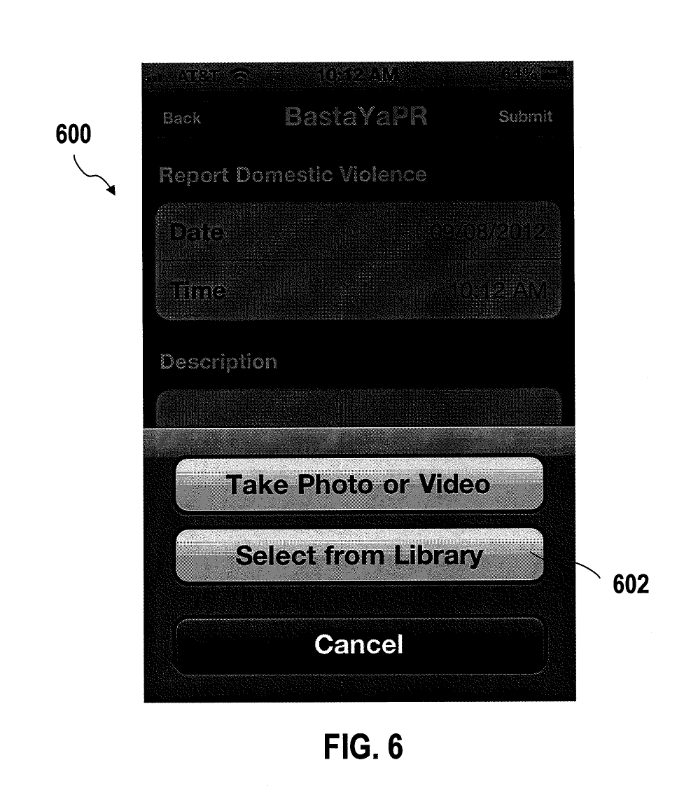

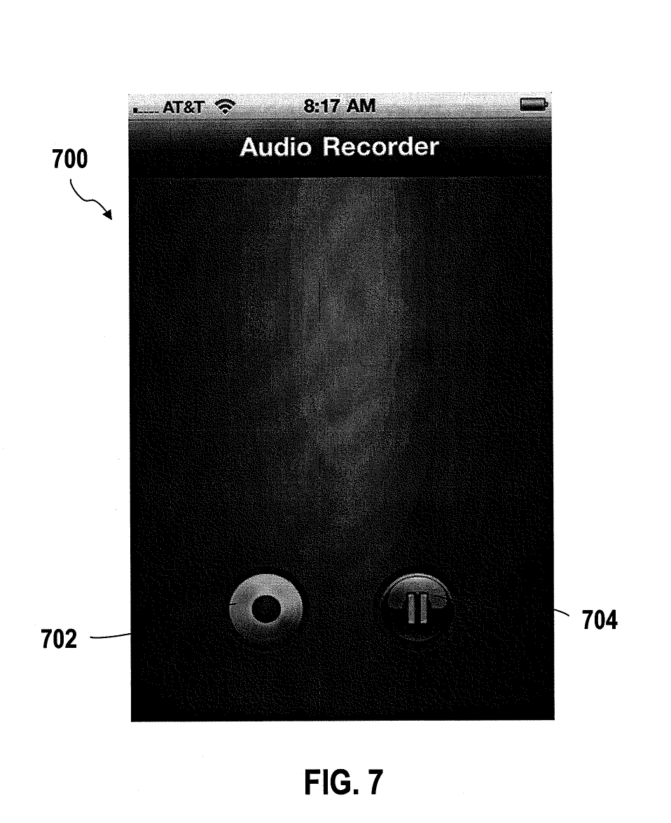

Upon selecting one of the icons 402 corresponding to the crime type most related to the incident, a user interface 500 appears for entering further information related to the incident to be reported including, for example, time, date, description, and optional photo, video, and/or audio information according to the illustrative embodiment shown in FIG. 5. Information fields 502, 504 for the time and date may automatically include the current date and time or may be manually modified by the user as necessary based on the time/date of the incident at issue. The user may input information associated with or describing the circumstances surrounding the incident into a text entry region (box) 506. The information input into text box 506 may include, for example but not limited to, description of a perpetrator(s) or suspect(s), description of the victim(s), description of the crime scene, description of the event(s) witnessed, and/or any other relevant information. Additionally, or alternatively, the user may optionally select options 508, 510 for including photo(s), video(s), and/or recorded audio from the incident scene. The photo(s), video(s), and/or audio information may be selected from a collection of previously taken or recorded photos, videos, or audio clips, or may be taken at the time the option 508, 510 for including is selected. FIG. 6 illustrates an example user interface 600 for selecting previously taken/saved photo or video information 602 for inclusion in an incident report message according to an illustrative embodiment. Upon selecting photo or video information 602, the user will be returned to user interface 500 for completion of the incident report and submission of the message to the pre-defined government public safety agency. Similarly, FIGS. 7 and 7A illustrate example user interfaces 700 and 700′, each including a record start option 702 or 702′ and a stop/pause option 704 or 704′, for optionally recording audio to be attached and included in the incident report message. The options 702 and 704 may be separate buttons as shown for example in FIG. 7 or options 702′ and 704′ may be the same button as shown for example in FIG. 7A. For example, as shown in FIG. 7A, by selecting the record start/stop option 702′, the voice recording starts and by again selecting the record start/stop option 702′ the recording stops and the user is returned to the incident report page 500 (see FIG. 5). Submission of the incident report message to the pre-defined government public safety agency may be completed by selecting “Submit” (“Someter”) 507 on user interface 500 (see FIG. 5). All of the compiled incident information may be sent, for example, as an email to a pre-defined email address associated with a receiving system of the government public safety agency. For security purposes, the email address associated with the pre-defined government public safety agency may be changed periodically by, for example, including the same in updates for the application 112.

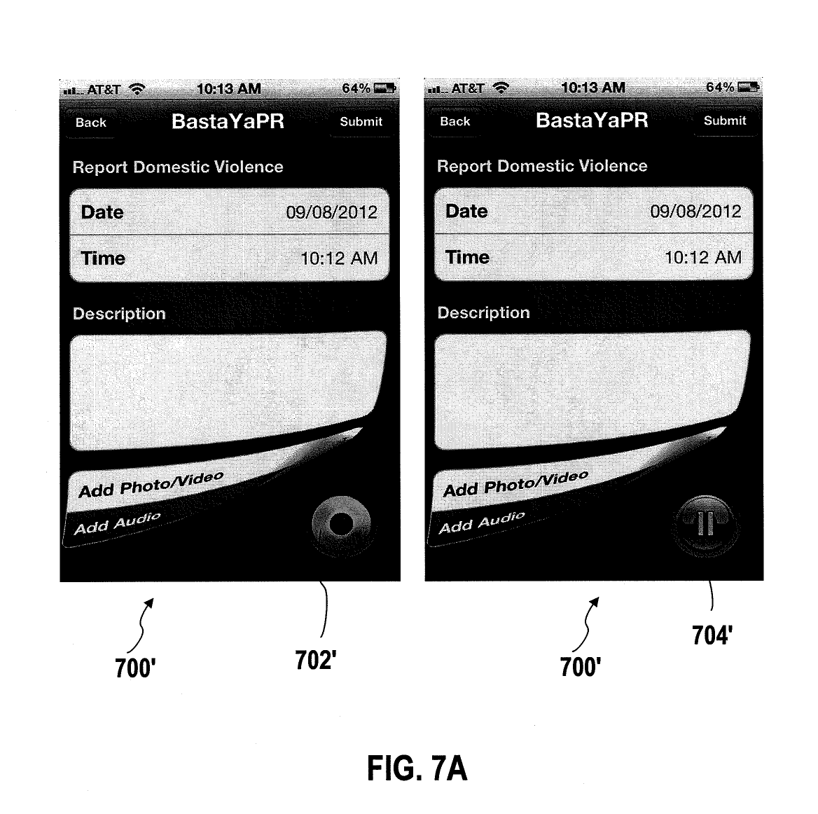

FIG. 8 illustrates an example process 800 for a user device according to the above-described illustrative embodiment.

FIG. 9 illustrates a screen shot of an example information screen 900 including selectable icons 902 and 904 which, when selected, obtain and display web-based information available from the designated government public safety agency. Information screen 900 may be accessed by, for example, selecting icon 406 in user interface screen 400 as shown in FIG. 4. The user may select icon 902 to obtain miscellaneous information from a web site of the designated government public safety agency such as, for example but not limited to, the ten most wanted persons according to the designated agency. The user may select icon 904 to display a map 906 that shows the user's location and nearby physical locations of the designated government public safety agency (e.g., nearby police precincts). FIG. 9A illustrates a screen shot of an example information screen 906 including nearby physical locations of the designated government public safety agency (e.g., nearby police precincts).

Additional features (not shown) may include, for example, including an information box(es) for the inclusion of other user specific information such as a Police informant ID number, a neighborhood watch ID number, or a Police department agent badge number where the application is used to submit official police incident reports. Furthermore, a messaging capability may be included for direct messaging (e.g., by SMS or email or the like) between the user device and the pre-defined government public safety agency or for the broadcast of messages from the pre-defined government public safety agency to registered users. Utilizing one or more features of the described embodiments, the method and system may allow a user to easily and efficiently gather and transmit multi-media data to a government public safety agency such as, for example, the police, fire department, or 911 service bureau or the like. The data may include photos, video, voice recording, GPS, cell phone number, electronic serial number of the cell phone, user entered text and other information in a package of information transmitted to the public safety entity for either immediate emergency response or a slower process of incidence reporting and analysis. The method and system may simplify information gathering and submission by a user and also may allow for the data to be sent to the public safety entity in either a required format configured to automatically integrate to an established complex incidence management system or emergency response system. Alternatively, or additionally, the data can be sent as attachments via email or other suitable wireless communication mechanism so that a public safety clerk can manually manage and enter such data into an established system.

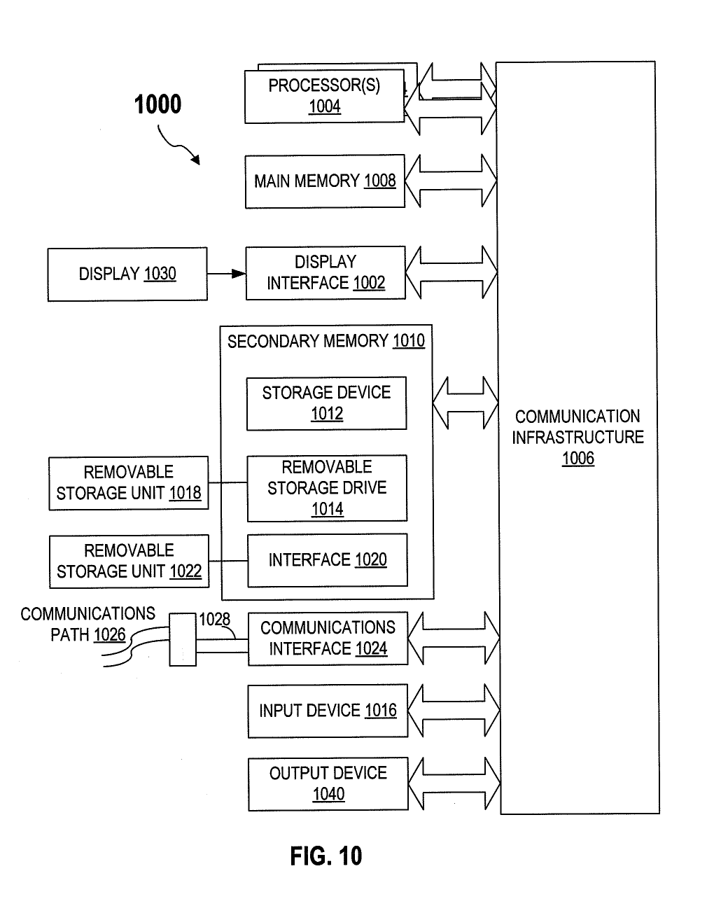

FIG. 10 depicts an exemplary embodiment of a computer system 1000 that may be used in association with, in connection with, and/or in place of, e.g., but not limited to, any of the foregoing components and/or systems. The system 100 for communicating information associated with an incident to a government public safety agency may be implemented with one or more computer systems 1000.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 1000 is shown in FIG. 10, depicting an exemplary embodiment of a block diagram of an exemplary computer system useful for implementing the present invention. Specifically, FIG. 10 illustrates an example computer 1000, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/VISTA, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 10.

The computer system 1000 may include one or more processors, such as, e.g., but not limited to, processor(s) 1004. The processor(s) 1004 may be connected to a communication infrastructure 1006 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 1000 may include a display interface 1002 that may forward, e.g., but not limited to, graphics, text, and other data, etc., from the communication infrastructure 1006 (or from a frame buffer, etc., not shown) for display on the display unit 1030.

The computer system 1000 may also include, e.g., but may not be limited to, a main memory 1008, random access memory (RAM), and a secondary memory 1010, etc. The secondary memory 1010 may include, for example, (but may not be limited to) a hard disk drive 1012 and/or a removable storage drive 1014, representing a floppy diskette drive, a magnetic tape drive, an optical disk drive, a magneto-optical disk drive, a compact disk drive CD-ROM, a digital versatile disk (DVD), a write once read many (WORM) device, a flash memory device, etc. The removable storage drive 1014 may, e.g., but not limited to, read from and/or write to a removable storage unit 1018 in a well known manner. Removable storage unit 1018, also called a program storage device or a computer program product, may represent, e.g., but not limited to, a floppy disk, a magnetic tape, an optical disk, a magneto-optical disk, a compact disk, a flash memory device, etc. which may be read from and written to by removable storage drive 1014. As will be appreciated, the removable storage unit 1018 may include a computer usable storage medium having stored therein computer software and/or data.

In alternative exemplary embodiments, secondary memory 1010 may include other similar devices for allowing computer programs or other instructions to be loaded into computer system 1000. Such devices may include, for example, a removable storage unit 1022 and an interface 1020. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1022 and interfaces 1020, which may allow software and data to be transferred from the removable storage unit 1022 to computer system 1000.

Computer 1000 may also include an input device 1016 such as, e.g., (but not limited to) a mouse or other pointing device such as a digitizer, a keyboard or other data entry device (none of which are labeled), and/or a touchscreen integrated with display 1030, etc.

Computer 1000 may also include output devices 1040, such as, e.g., (but not limited to) display 1030, and display interface 1002. Computer 1000 may include input/output (I/O) devices such as, e.g., (but not limited to) communications interface 1024, cable 1028 and communications path 1026, etc. These devices may include, e.g., but not limited to, a network interface card, and modems (neither are labeled). Communications interface 1024 may allow software and data to be transferred between computer system 1000 and external devices. Examples of communications interface 1024 may include, e.g., but may not be limited to, a modem, a network interface (such as, e.g., an Ethernet card), a communications port, a Personal Computer Memory Card International Association (PCMCIA) slot and card, a transceiver, a global positioning system receiver, etc. Software and data transferred via communications interface 1024 may be in the form of signals 1028 which may be electronic, electromagnetic, optical or other signals capable of being received by communications interface 1024. These signals 1028 may be provided to communications interface 1024 via, e.g., but not limited to, a communications path 1026 (e.g., but not limited to, a channel). This channel 1026 may carry signals 1028, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to non-transitory media such as, e.g., but not limited to removable storage drive 1014, a hard disk installed in hard disk drive and/or other storage device 1012, etc. These computer program products may provide software to computer system 1000. The invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses and/or devices for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, an exemplary machine-readable storage medium may include, e.g., but not limited to, read only memory (ROM); random access memory (RAM); magnetic disk storage media; optical storage media; magneto-optical storage media; flash memory devices.

Computer programs (also called computer control logic), may include object oriented computer programs, and may be stored in main memory 1008 and/or the secondary memory 1010 and/or removable storage drive 1014, removable storage unit 1018, removable storage unit 1022, also called computer program products. Such computer programs, when executed, may enable the computer system 1000 to perform the features of the inventive embodiments discussed herein. In particular, the computer programs, when executed, may enable the processor or processors 1004 to provide a method of communicating information associated with an incident to a government public safety agency according to an exemplary embodiment of the present invention.

In another exemplary embodiment, the invention may be directed to a computer program product comprising a computer readable medium having control logic (computer software) stored therein. The control logic, when executed by the processor 1004, may cause the processor 1004 to perform the functions of the invention as described herein. In another exemplary embodiment where the invention may be implemented using software, the software may be stored in a computer program product and loaded into computer system 1000 using, e.g., but not limited to, removable storage drive 1014, hard drive 1012 or communications interface 1024, etc. The control logic (software), when executed by the processor 1004, may cause the processor 1004 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

The exemplary embodiment of the present invention makes reference to, e.g., but not limited to, communications links, wired, and/or wireless networks. Wired networks may include any of a wide variety of well known means for coupling voice and data communications devices together. A brief discussion of various exemplary wireless network technologies that may be used to implement the embodiments of the present invention now are discussed. The examples are non-limiting. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB) networks, etc. Also included may be a dedicated public safety wireless network (PSWN) such as, for example, a local, statewide, or nationwide mobile broadband network for emergency services (e.g., in the D Block 700 MHz band).

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d, g, or n, such as, e.g., but not limited to, IEEE std. 802.11a, b, d, g and n (including, e.g., but not limited to IEEE 802.11g-2003, etc.), etc.

According to an exemplary embodiment, exemplary methods set forth herein may be performed by an exemplary one or more computer processor(s) adapted to process program logic, which may be embodied on an exemplary computer accessible storage medium, which when such program logic is executed on the exemplary one or more processor(s) may perform such exemplary steps as set forth in the exemplary methods.

While various embodiments of the present invention have been described above, it should be understood that they have been presented by way of example only, and not limitation. Thus, the breadth and scope of the present invention should not be limited by any of the above-described embodiments, but should instead be defined only in accordance with the following claims and their equivalents.

We claim:

1. A computer-implemented method for communicating information associated with an incident to a designated government public safety agency, the method comprising:
displaying a plurality of selectable icons each associated with a type of criminal offense on a display of a device for a user to select the type of criminal offense associated with the incident;
displaying a text entry region on the display of the device for allowing the user to optionally enter text information associated with the incident;
displaying on the display of the device at least one other selectable option for allowing the user to optionally take or select a photo, a video, or an audio recording associated with the incident;
preparing, by the device, a message to send, the message including one or more of user identification information, user contact information, location-based information, the selected type of criminal offense, text information associated with the incident, photo information associated with the incident, video information associated with the incident, and/or audio information associated with the incident; and
sending, by the device, the message to a receiving system of the designated government public safety agency.

2. The method of claim 1, further comprising:
displaying a setup screen on the display of the device for the user to optionally enter or select the user identification information and/or the user contact information.

3. The method of claim 2, further comprising:
displaying on the setup screen, or on a different setup screen, on the display of the device, a selectable option for allowing the user to optionally enable location-based information.

4. The method of claim 2, further comprising:
displaying on the setup screen, or on a different setup screen, on the display of the device, another selectable option for allowing the user to optionally enable anonymous information submission.

5. The method of claim 1, wherein the message is an email message addressed to a pre-defined email address associated with the receiving system of the designated government public safety agency.

6. The method of claim 1, further comprising:
receiving, on the device, a software application including code segments configured to perform the displaying, preparing, and sending steps.

7. The method of claim 1, further comprising:
receiving, by the device, data associated with the incident from a receiving system of the designated government public safety agency.

8. A method comprising:
offering, on a remote server, a software program for download, by a user device, the program including code segments configured to perform the steps according to the method of claim 1.

9. A computer-based system for communicating information associated with an incident to a designated government public safety agency, the computer-based system comprising one or more computers having a processor and software stored in a computer readable medium, the software comprising code segments executable by the processor for performing the method of claim 1.

10. A computer-based system for communicating information associated with an incident to a designated government public safety agency, the system comprising:
means for displaying a plurality of selectable icons each associated with a type of criminal offense on a display of a device for a user to select the type of criminal offense associated with the incident;
means for displaying a text entry region on the display of the device for allowing the user to optionally enter text information associated with the incident;
means for displaying on the display of the device at least one other selectable option for allowing the user to optionally take or select a photo, a video, or an audio recording associated with the incident;
means for preparing, by the device, a message to send, the message including one or more of user identification information, user contact information, location-based information, the selected type of criminal offense, the text information associated with the incident, photo information associated with the incident, video information associated with the incident, and/or audio information associated with the incident; and
means for sending, by the device, the message to a receiving system of the designated government public safety agency.

11. The system of claim 10, further comprising:
means for displaying a setup screen on a display of a device for a user to optionally enter or select the user identification information and/or the user contact information.

12. The system of claim 11, further comprising:
means for displaying on the setup screen, or on a different setup screen, on the display of the device, a selectable option for allowing the user to optionally enable location-based information;

13. The system of claim 11, further comprising:
means for displaying on the setup screen, or on a different setup screen, on the display of the device, another selectable option for allowing the user to optionally enable anonymous information submission.

14. The system of claim 10, wherein the message is an email message addressed to a pre-defined email address associated with the receiving system of the designated government public safety agency.

15. The system of claim 10, further comprising:
means for receiving, by the device, data associated with the incident from a receiving system of the designated government public safety agency.
